(19) United States
(12) Patent Application Publication
(10) Pub. No.: US 2007/0286103 A1
(43) Pub. Date: Dec. 13, 2007

(54) System and method for digital communication having puncture cycle based multiplexing scheme with unequal error protection (UEP)

(76) Inventors: Huaning Niu, Sunnyvale, CA (US); Pengfei Xia, Mountain View, CA (US); Chiu Ngo, San Francisco, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/724,760

(22) Filed: Mar. 15, 2007

Related U.S. Application Data
(60) Provisional application No. 60/812,314, filed on Jun. 8, 2006.

(51) Int. Cl. H04B 7/00; H04B 1/66

(52) U.S. Cl. 370/310; 386/46; 386/E09.001; 375/240.1; 375/E07.001

(57) ABSTRACT

A system for processing high definition video data to be transmitted over a wireless medium is disclosed. In one embodiment, the system includes i) a plurality of parallel convolutional encoders configured to encode a plurality of video data streams, respectively, so as to create a plurality of encoded data streams and a multiplexer configured to multiplex the plurality of encoded data streams so as to create a multiplexed data stream, wherein the multiplexed data stream includes a uniform bit pattern which is repeated with a period. According to at least one embodiment, the puncture cycle based multiplexer provides a simple solution for UEP and provides the highest frequency diversity for each data stream.

### CROSS-REFERENCE TO RELATED APPLICATIONS

This application claims priority under 35 U.S.C. § 119(e) from provisional application No. 60/812,314 filed on Jun. 8, 2006, which is hereby incorporated by reference. This application also relates to U.S. patent application (Attorney Docket Number: SAMINF.040A) entitled “System and method for digital communication having a frame format and parsing scheme with parallel convolutional encoders” and U.S. patent application (Attorney Docket Number: SAMINF.045A) entitled “System and method for digital communication using multiple parallel encoders,” concurrently filed as this application, which are incorporated by reference.

### BACKGROUND OF THE INVENTION

1. Field of the Invention

The present invention relates to wireless transmission of video information, and in particular, to transmission of uncompressed high definition video information over wireless channels.

2. Description of the Related Technology

With the proliferation of high quality video, an increasing number of electronic devices, such as consumer electronic devices, utilize high definition (HD) video which can require about 1 Gbps (bits per second) in bandwidth for transmission. As such, when transmitting such HD video between devices, conventional transmission approaches compress the HD video to a fraction of its size to lower the required transmission bandwidth. The compressed video is then decompressed for consumption. However, with each compression and subsequent decompression of the video data, some data can be lost and the picture quality can be reduced.

The High-Definition Multimedia Interface (HDMI) specification allows transfer of uncompressed HD signals between devices via a cable. While consumer electronics makers are beginning to offer HDMI-compatible equipment, there is not yet a suitable wireless (e.g., radio frequency) technology that is capable of transmitting uncompressed HD video signals. Wireless local area network (WLAN) and similar technologies can suffer interference issues when several devices are connected which do not have the bandwidth to carry the uncompressed HD signals.

### SUMMARY OF CERTAIN INVENTIVE ASPECTS

One aspect of the invention provides a system for processing wireless high definition video data to be transmitted over a wireless medium, the system comprising: i) a plurality of parallel convolutional encoders configured to input a plurality of video data streams and output a plurality of encoded data streams, respectively and ii) a multiplexer configured to multiplex the plurality of encoded data streams into a multiplexed data stream, wherein the multiplexed data stream includes a uniform bit pattern which is repeated with a period.

Another aspect of the invention provides a method of processing wireless high definition video data to be transmitted over a wireless medium, the method comprising: i) RS encoding a received video data stream into an RS encoded data stream, ii) parsing the RS encoded data stream into a plurality of sub-video data streams, iii) convolutional encoding the plurality of sub-video data streams in parallel into a plurality of encoded data streams and iv) multiplexing the plurality of encoded data streams into a multiplexed data stream, wherein the multiplexed data stream includes a uniform bit pattern which is repeated with a period.

Still another aspect of the invention provides one or more processor-readable storage devices having processor-readable code embodied on the processor-readable storage devices, the processor-readable code for programming one or more processors to perform a method of processing wireless high definition video data to be transmitted over a wireless medium, the method comprising: i) RS encoding a received video data stream into an RS encoded data stream, ii) parsing the RS encoded data stream into a plurality of sub-video data streams, iii) convolutional encoding the plurality of sub-video data streams in parallel into a plurality of encoded data streams and iv) multiplexing the plurality of encoded data streams into a multiplexed data stream, wherein the multiplexed data stream includes a uniform bit pattern which is repeated with a period.

Still another aspect of the invention provides a system for processing wireless high definition video data to be transmitted over a wireless medium, the system comprising: i) an error control code section configured to encode a received video data stream into an encoded data stream, ii) a parser configured to parse the encoded data stream into a plurality of sub-video data streams, iii) a plurality of parallel convolutional encoders configured to input the plurality of sub-video data streams and output a plurality of encoded data streams, respectively and iv) a multiplexer configured to multiplex the plurality of encoded data streams into a multiplexed data stream, wherein the multiplexed data stream includes a uniform bit pattern which is repeated with a period.

Still another aspect of the invention provides a system for processing wireless high definition video data to be transmitted over a wireless medium, the system comprising: i) a Reed Solomon (RS) encoder configured to encode a received video data stream into an RS encoded data stream, ii) a parser configured to parse the RS encoded data stream into a plurality of sub-video data streams, iii) a plurality of parallel error control code sections configured to input the plurality of sub-video data streams and output a plurality of encoded data streams, respectively and iv) a multiplexer configured to multiplex the plurality of encoded data streams into a multiplexed data stream, wherein the multiplexed data stream includes a uniform bit pattern which is repeated with a period.

Yet another aspect of the invention provides a system for processing wireless high definition video data to be transmitted over a wireless medium, the system comprising: i) a first error control code section configured to encode a received video data stream into an encoded data stream, ii) a parser configured to parse the encoded data stream into a plurality of sub-video data streams, iii) a plurality of second error control code sections configured to input the plurality of sub-video data streams and output a plurality of encoded data streams, respectively and iv) a multiplexer configured to multiplex the plurality of encoded data streams into a multiplexed data stream, wherein the multiplexed data stream includes a uniform bit pattern which is repeated with a period.

### BRIEF DESCRIPTION OF THE DRAWINGS

FIG. 1 is a functional block diagram of a wireless network that implements uncompressed HD video transmission between wireless devices according to one embodiment.

FIG. 2 is a functional block diagram of an example communication system for transmission of uncompressed HD video over a wireless medium, according to one embodiment.

FIG. 3 illustrates an exemplary wireless HD video transmitter system according to one embodiment of the invention.

FIG. 4 illustrates an exemplary wireless HD video transmitter system according to another embodiment of the invention.

FIG. 5 illustrates an exemplary wireless HD video transmitter system according to still another embodiment of the invention.

FIG. 6 is a conceptual diagram of illustrating exemplary puncture patterns for different coding rates, based on a common mother code according to one embodiment of the invention.

FIG. 7 is a flowchart explaining how to determine the multiplexing cycle and patterns according to one embodiment of the invention.

FIG. 8 is a conceptual diagram illustrating how different bits are multiplexed together in a wireless HD video processing procedure according to one embodiment of the invention.

### DETAILED DESCRIPTION OF CERTAIN INVENTIVE EMBODIMENTS

Certain embodiments provide a method and system for transmission of uncompressed HD video information from a sender to a receiver over wireless channels.

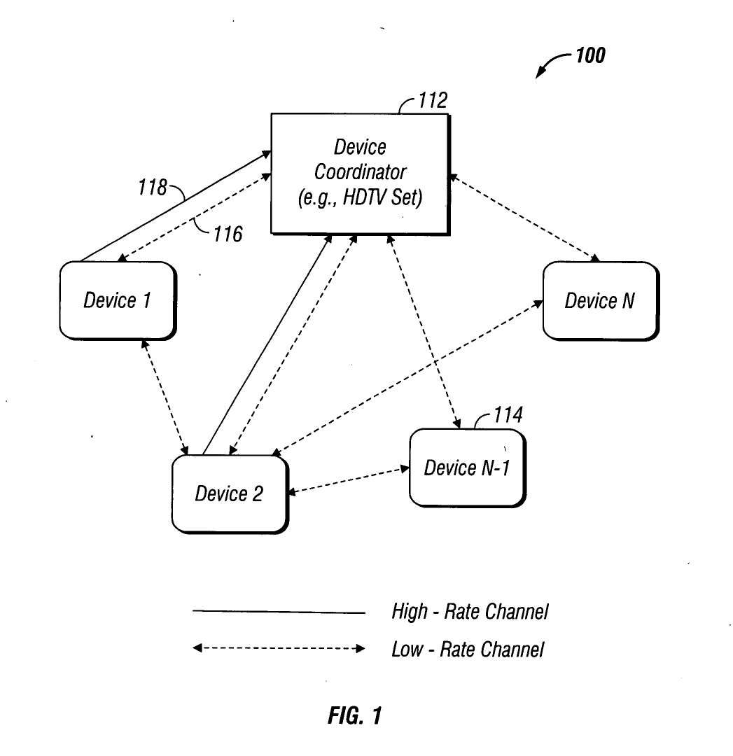

Example implementations of the embodiments in a wireless high definition (HD) audio/video (A/V) system will now be described. FIG. 1 shows a functional block diagram of a wireless network 100 that implements uncompressed HD video transmission between A/V devices such as an A/V device coordinator and A/V stations, according to certain embodiments. In other embodiments, one or more of the devices can be a computer, such as a personal computer (PC). The network 100 includes a device coordinator 112 and multiple A/V stations 114 (e.g., Device 1 . . . Device N). The A/V stations 114 utilize a low-rate (LR) wireless channel 116 (dashed lines in FIG. 1), and may use a high-rate (HR) channel 118 (heavy solid lines in FIG. 1), for communication between any of the devices. The device coordinator 112 uses a low-rate channel 116 and a high-rate wireless channel 118, for communication with the stations 114.

Each station 114 uses the low-rate channel 116 for communications with other stations 114. The high-rate channel 118 supports single direction unicast transmission over directional beams established by beamforming, with e.g., multi-Gb/s bandwidth, to support uncompressed HD video transmission. For example, a set-top box can transmit uncompressed video to a HD television (HDTV) over the high-rate channel 118. The low-rate channel 116 can support bi-directional transmission, e.g., with up to 40 Mbps throughput in certain embodiments. The low-rate channel 116 is mainly used to transmit control frames such as acknowledgement (ACK) frames. For example, the low-rate channel 116 can transmit an acknowledgement from the HDTV to the set-top box. It is also possible that some low-rate data like audio and compressed video can be transmitted on the low-rate channel between two devices directly. Time division duplexing (TDD) is applied to the high-rate and low-rate channel. At any one time, the low-rate and high-rate channels cannot be used in parallel for transmission, in certain embodiments. Beamforming technology can be used in both low-rate and high-rate channels. The low-rate channels can also support omni-directional transmissions.

In one example, the device coordinator 112 is a receiver of video information (hereinafter “receiver 112”), and the station 114 is a sender of the video information (hereinafter “sender 114”). For example, the receiver 112 can be a sink of video and/or audio data implemented, such as, in an HDTV set in a home wireless network environment which is a type of WLAN. In another embodiment, the receiver 112 may be a projector. The sender 114 can be a source of uncompressed video or audio. Examples of the sender 114 include a set-top box, a DVD player or recorder, digital camera, camcorder, other computing device (e.g., laptop, desktop, PDA, etc.) and so forth.

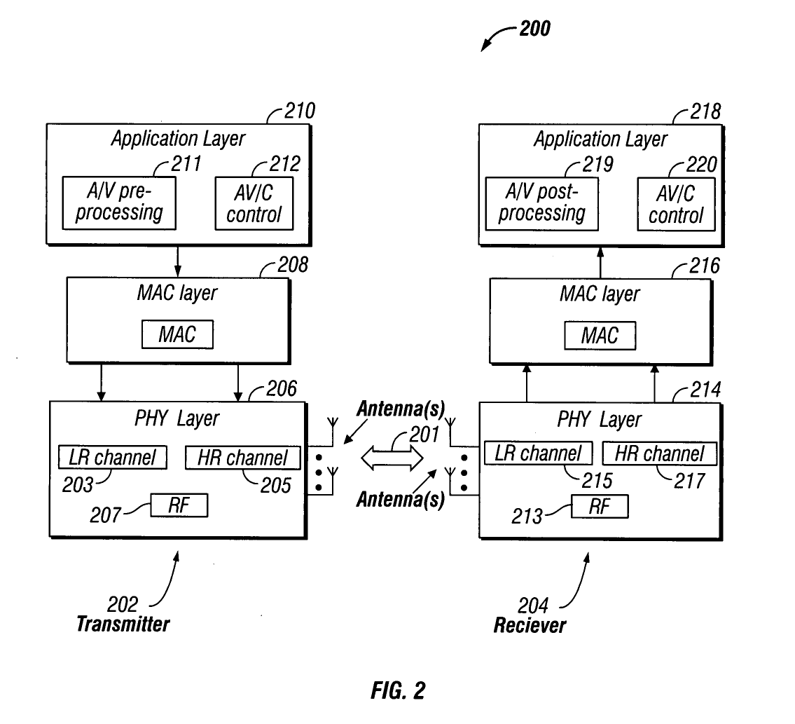

FIG. 2 illustrates a functional block diagram of an example communication system 200. The system 200 includes a wireless transmitter 202 and wireless receiver 204. The transmitter 202 includes a physical (PHY) layer 206, a media access control (MAC) layer 208 and an application layer 210. Similarly, the receiver 204 includes a PHY layer 214, a MAC layer 216, and an application layer 218. The PHY layers provide wireless communication between the transmitter 202 and the receiver 204 via one or more antennas through a wireless medium 201.

The application layer 210 of the transmitter 202 includes an A/V pre-processing module 211 and an audio video control (AV/C) module 212. The A/V pre-processing module 211 can perform pre-processing of the audio/video such as partitioning of uncompressed video. The AV/C module 212 provides a standard way to exchange A/V capability information. Before a connection begins, the AV/C module negotiates the A/V formats to be used, and when the need for the connection is completed, AV/C commands are used to stop the connection.

In the transmitter 202, the PHY layer 206 includes a low-rate (LR) channel 203 and a high rate (HR) channel 205 that are used to communicate with the MAC layer 208 and with a radio frequency (RF) module 207. In certain embodiments, the MAC layer 208 can include a packetization module (not shown). The PHY/MAC layers of the transmitter 202 add PHY and MAC headers to packets and transmit the packets to the receiver 204 over the wireless channel 201.

In the wireless receiver 204, the PHY/MAC layers 214, 216, process the received packets. The PHY layer 214 includes a RF module 213 connected to the one or more antennas. A LR channel 215 and a HR channel 217 are used to communicate with the MAC layer 216 and with the RF module 213. The application layer 218 of the receiver 204 includes an A/V post-processing module 219 and an AV/C module 220. The module 219 can perform an inverse processing method of the module 211 to regenerate the uncompressed video, for example. The AV/C module 220 operates in a complementary way with the AV/C module 212 of the transmitter 202.

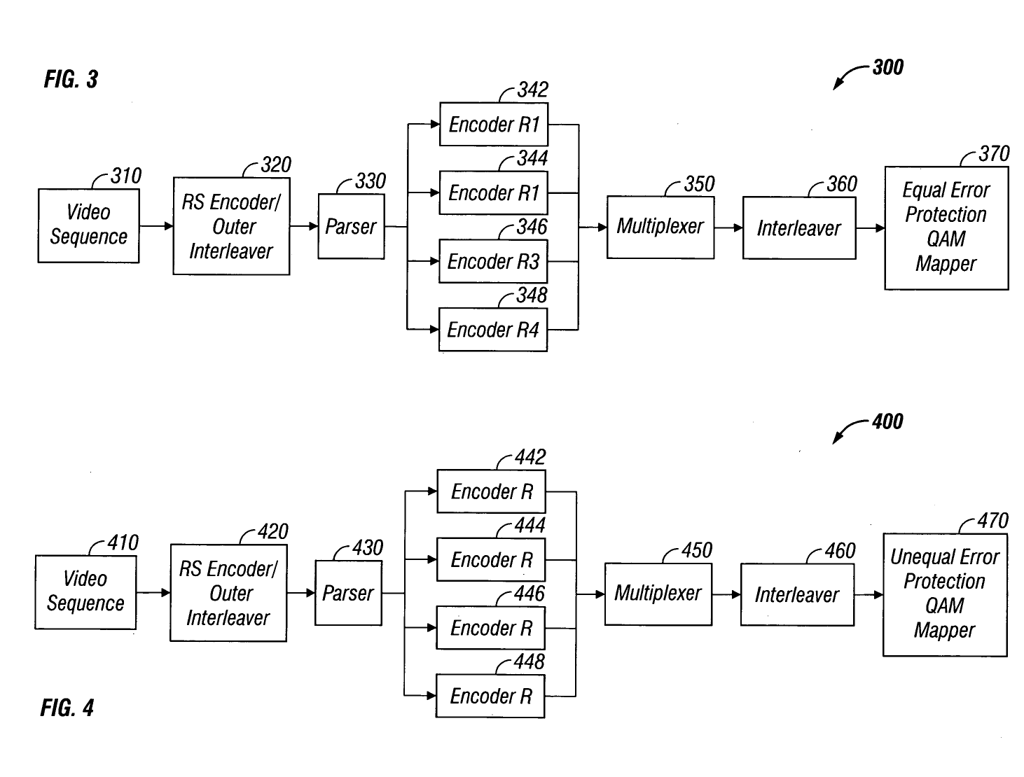

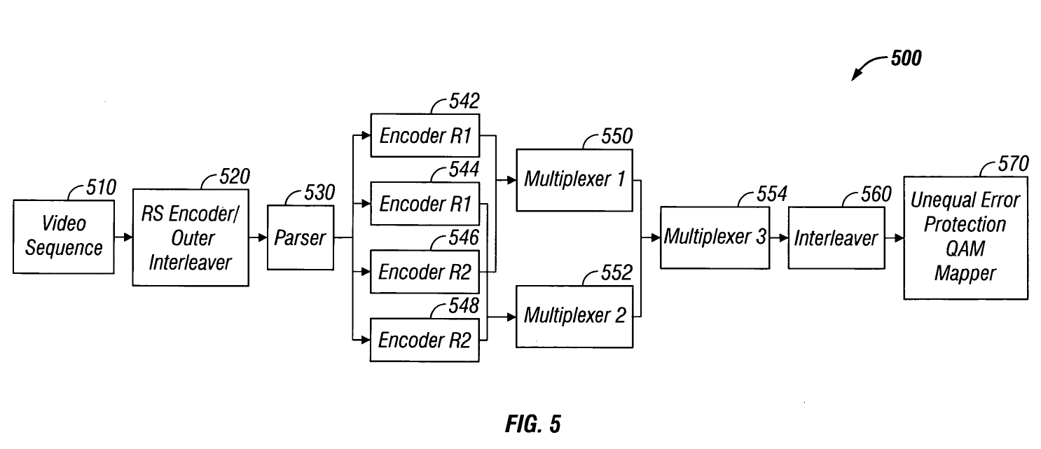

FIG. 3 illustrates an exemplary wireless HD video transmitter system 300 according to one embodiment of the invention. FIG. 4 illustrates an exemplary wireless HD video transmitter system 400 according to another embodiment of the invention. FIG. 5 illustrates an exemplary wireless HD video transmitter system 500 according to still another embodiment of the invention. Embodiments of the invention provide unequal error protection (UEP) for incoming video data streams. One embodiment provides UEP through coding only (will described in detail later) as shown in FIG. 3. Another embodiment provides UEP through modulation only (will described in detail later) as shown in FIG. 4. Still another embodiment provides UEP through the combination of modulation and coding (will described in detail later) as shown in FIG. 5.

Referring to FIG. 3, the system 300 includes a video sequence 310, a Reed Solomon (RS) encoder/outer interleaver 320, a parser 330, a plurality of encoders 342-348, a multiplexer 350, an interleaver 360 and an equal error protection (EEP) quadrature amplitude modulation (QAM) mapper 370.

In one embodiment, the video sequence 310 belongs to the MAC layer 208, and the remaining elements of the FIG. 3 system belongs to the PHY layer 206 (see FIG. 2). Although four encoders are illustrated in FIG. 3, there may be more encoders (e.g., 8 or greater) or less encoders (e.g., 1 or 2) depending on specific applications. In one embodiment, all of the elements of the FIG. 3 system can be embodied by software, hardware, or a combination. This applies to the embodiments of FIGS. 4 and 5.

The RS encoder/outer interleaver 320 performs RS encoding and interleaving on a sequence of video pixels 310. The parser 330 parses incoming bit streams into the encoders 342-348. In one embodiment, the parser 330 is a switch or demultiplexer which parses data in a bit-by-bit or group-by-group manner. In one embodiment, the output of the parser 330 is parsed into N branches (e.g., N=4 or 8), with each branch encoded by a separate encoder (342-348). A detailed description regarding the operation of a parser in WiHD is explained in U.S. patent application (Attorney Docket Number: SAMINF.040A) entitled “System and method for digital communication having a frame format and parsing scheme with parallel convolutional encoders” concurrently filed as this application, which is incorporated by reference.

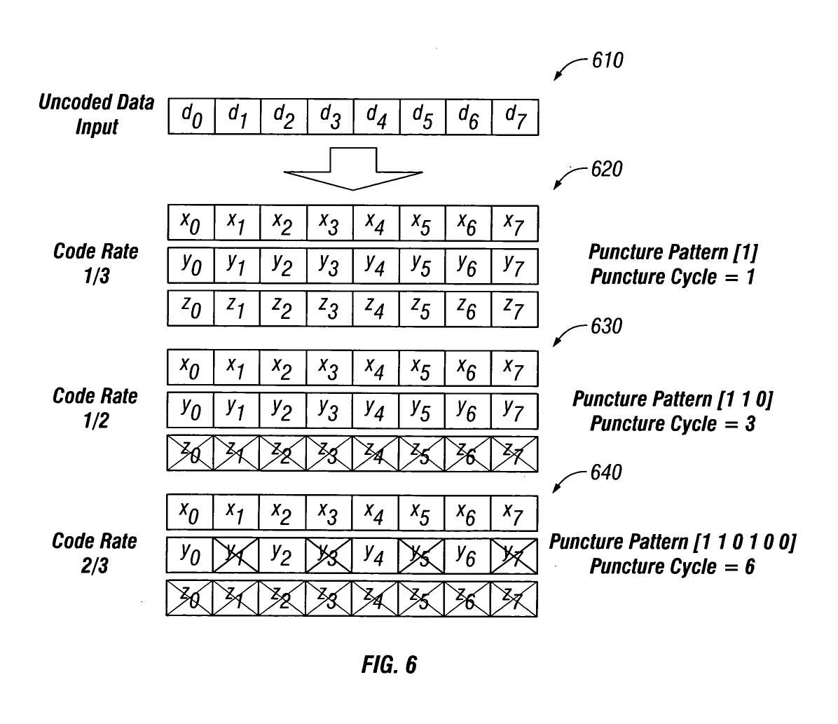

In one embodiment, each of the encoders 342-348 is a convolutional encoder. In one embodiment, the encoders 342-348 use different convolutional code rates R1-R4, respectively. In one embodiment, different code rates are generated from the same mother code and different puncturing patterns (see FIG. 6). In another embodiment, at least two of the encoders 342-348 may use different convolutional code rate with respect to each other. A description regarding the operation of convolutional encoders in WiHD is explained in U.S. patent application (Attorney Docket Number: SAMINF.045A) entitled “System and method for digital communication using multiple parallel encoders” concurrently filed as this application, which is incorporated by reference. 100321 In one embodiment, the RS encoder/outer interleaver 320 and the convolutional encoders 342-348 together perform FEC described with respect to FIG. 2. In one embodiment, the encoders 342-348 provide unequal error protection (UEP) for incoming data bits. For example, the encoders 342, 344 may encode MSB data using one code rate and the encoders 346, 348 may encode LSB data using another code rate, while different coding rates in general lead to different error protection capability. In this example, the MSB encoding provides better error protection than the LSB encoding.

The multiplexer 350 combines the bit streams output from the encoders 342-348. In one embodiment, the multiplexer 350 receives bit streams encoded with different coding rates (R1-R4; see FIG. 3) and performs a puncture cycle based multiplexing (will be described in detail later). The interleaver 360 performs interleaving on the output of the multiplexer 350. The EEP QAM mapper 370 performs QAM mapping on the output of the interleaver 360. In one embodiment, the QAM mapper 370 provides EEP modulation for the interleaved data where all data bits are equally modulated in terms of error protection. As the encoders 342-348 provide UEP (even if the mapper 370 performs EEP), the system 300 as a whole provides UEP for the received video data.

The QAM modulated data is, after known beamforming, transmitted to a WiHD video data receiver over the wireless channel 201 (see FIG. 2). In one embodiment, the WiHD video data receiver may include a plurality of parallel convolutional decoders corresponding to the plurality of parallel convolutional encoders. The description of this paragraph may apply to the embodiments of FIGS. 4 and 5.

Referring to FIG. 4, the system 400 includes a video sequence 410, an RS encoder/outer interleaver 420, a parser 430, a plurality of encoders 442-448, a multiplexer 450, an interleaver 460 and an UEP QAM mapper 470. The RS encoder/outer interleaver 420, the parser 430, the encoders 442-448 and the interleaver 460 are substantially the same as those of the FIG. 3 system.

In one embodiment, the encoders 442-448 use the same convolutional code rate (R). In this embodiment, the encoders 442-448 provide equal error protection (EEP) for all incoming data bits. In one embodiment, the multiplexer is a bit-by-bit round-robin multiplexer (also termed a standard or regular multiplexer), which receives and multiplexes bit streams encoded with the same coding rate (rate R; see FIG. 4).

In one embodiment, the UEP QAM mapper 470 provides unequal error protection (UEP) for the output of the interleaver 460. For example, the mapper 470 may differently map MSB data and LSB data. In this example, the MSB modulation provides better error protection than the LSB modulation. As the mapper 470 performs UEP, the system 400 as a whole provides UEP for the received video data.

Referring to FIG. 5, the system 500 includes a video sequence 510, an RS encoder/outer interleaver 520, a parser 530, a plurality of encoders 542-548, a first multiplexer 550, a second multiplexer 552, a third multiplexer 554, an interleaver 560 and an UEP QAM mapper 570. The RS encoder/outer interleaver 520, the parser 530, the encoders 542-548 and the interleaver 560 are substantially the same as those of the FIG. 3 system. Furthermore, the UEP QAM mapper 570 is substantially the same as that of the FIG. 4 system.

In one embodiment, the encoders 542, 544 use a convolutional code rate (R1) different from that (R2) of the encoders 546, 548. In one embodiment, the encoders 542-548 provide UEP for incoming data bits. For example, the encoders 542, 544 may encode MSB data and the encoders 546, 548 may encode LSB data, and vice versa. In one embodiment, the UEP QAM mapper 570 provides UEP for the output of the inerleaver 560. In this embodiment, both the encoders 542-548 and the mapper 570 provide UEP protection for the video data streams.

In one embodiment, the first multiplexer 550 combines the bit streams of the encoders 542 and 546 having code rates R1 and R2, respectively, and the second multiplexer 552 combines the bit streams of the encoders 544 and 548 having code rates R1 and R2, respectively. In this embodiment, each of the multiplexers 550, 552 performs a puncture cycle based multiplexing (will be described in detail later). In one embodiment, the third multiplexer 554 is a standard multiplexer which multiplexes the output of the first and second multiplexers 550, 552 that have the same data format.

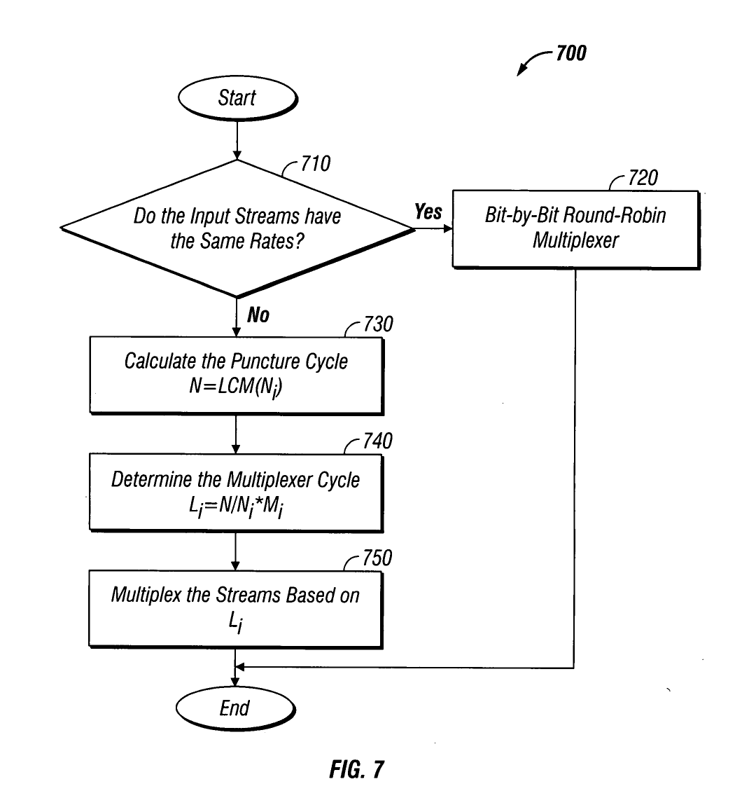

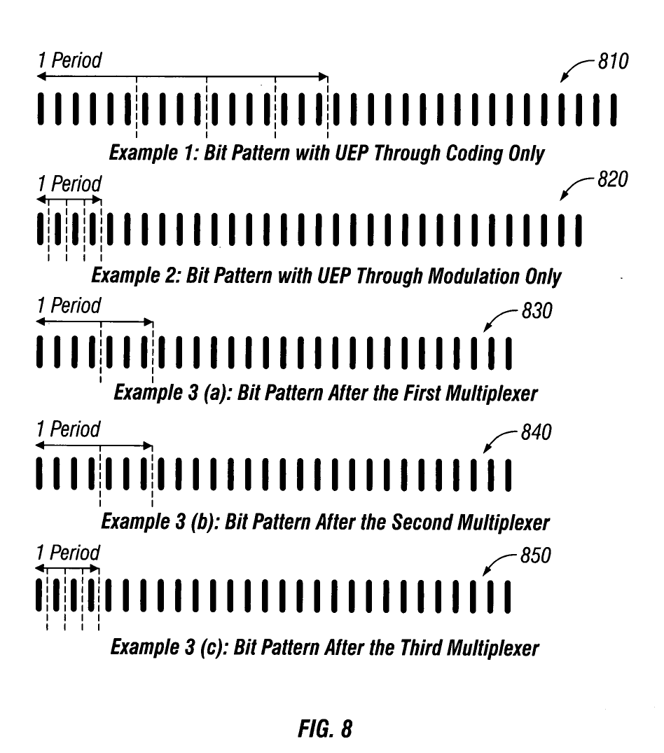

Hereinafter, referring to FIGS. 6-8, the operation of the systems 300-500 will be described. FIG. 6 is a conceptual diagram of illustrating exemplary puncture patterns for different coding rates, based on a common mother code according to one embodiment of the invention. FIG. 7 illustrates an exemplary flowchart which shows how to determine the multiplexing scheme in wireless HD according to one embodiment of the invention. FIG. 8 is a conceptual diagram illustrating how different bits are multiplexed together in a wireless HD video processing procedure according to one embodiment of the invention. In one embodiment, the transmitting procedure 700 is implemented in a conventional programming language, such as C or C++ or another suitable programming language. In one embodiment of the invention, the program is stored on a computer accessible storage medium at a WiHD transmitter, for example, a device coordinator 112 or devices (1-N) 114 as shown in FIG. 1. In another embodiment, the program can be stored in other system locations so long as it can perform the transmitting procedure 700 according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc. 100421 In another embodiment, at least one of the device coordinator 112 and devices (1-N) 114 comprises a processor (not shown) configured to or programmed to perform the transmitting procedure 700. The program may be stored in the processor or a memory of the coordinator 112 and/or the devices (1-N) 114. In various embodiments, the processor may have a configuration based on Intel Corporation's family of microprocessors, such as the Pentium family and Microsoft Corporation's windows operating systems such as Windows 95, Windows 98, Windows 2000 or Windows NT. In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9×/ME/XP, Macintosh OS, OS/2 and the like. In another embodiment, the transmitting procedure 700 can be implemented with an embedded software. 100431 Depending on the embodiments, additional states may be added, others removed, or the order of the states changes in FIG. 7. In one embodiment, the procedure 700 is stored in the multiplexers 350, 450 and 550-554.

In state 710, it is determined whether the input data streams have the same code rate. As discussed above, each of the multiplexers 350, 550 and 552 receives data encoded with possibly different code rates. The multiplexers 450 and 554 receive data having the same format. If the input data streams have the same code rate such as in the multiplexer 450 or 554, the data then can be multiplexed by, for example, a standard or regular multiplexer (720). In one embodiment, the states 710 and 720 may be omitted. In this embodiment, the multiplexing cycle (Lᵢ; number of bits to be multiplexed together each time) for all data rates (same or not) can be directly calculated from the states 730-750.

If the input data streams do not have the same code rate such as in the multiplexer 350, 550 and 552, the puncture cycle N (also termed a representative puncture cycle) is calculated from the relationship of: N=LCM (Nᵢ) (730). Here, LCM is the least common multiple of the puncture cycles Nᵢ (also termed individual puncture cycles) of each code rate in each stream. Referring to FIG. 6, an example of a punctured code is illustrated. The puncture pattern is defined by the code itself, and the puncture cycle is the length of the puncture pattern as shown in FIG. 6. In FIG. 6, the uncoded data input 610 is encoded based on the code rates and the puncture patterns 620-640.

The multiplexing cycle (Lᵢ) is calculated from the following relationship: Lᵢ=(N/Nᵢ)×Mᵢ, where Mᵢ is the number of encoded bits left in each puncture cycle (740). The video data streams are multiplexed based on the calculated Lᵢ (750). Hereinafter, the procedure to calculate Lᵢ will be described in each of the systems of FIGS. 3-5.

### Multiplexer 350 of FIG. 3 (UEP Through Coding Only)

It is assumed in the FIG. 3 system that R1=1/3, R2=1/2, R3=1/2 and R4=2/3. Referring to FIG. 6, the puncture cycle for rate 1/3 (R1) is 1, rate 1/2 (R2, R3) is 3 and rate 2/3 (R4) is 6. First, the individual puncture cycles (Nᵢ) of each rate are determined from the puncture patterns (620-640) in FIG. 6 as follows: N₁=1, N₂=3, N₃=3, N₄=6. In one embodiment, the representative puncture cycle (N) is obtained from the relationship of: N=LCM (Nᵢ=1, 3, 3, 6)=6. Next, Mᵢ (the number of encoded bits left in each puncture cycle) is determined from the puncture patterns (620-640) in FIG. 6 as follows: M₁=1, M₂=M₃=2, M₄=3 (see the number of “1” in each puncture pattern). Using the relationship of Lᵢ=(N/Nᵢ)×Mᵢ, the multiplexing cycle (Lᵢ) is calculated as follows: L₁=(N/Nᵢ)×M₁=6; L₂=(N/N₂)×M₂=4; L₃=(N/N₃)×M₃=4; L₄=(N/N₄)×M₄=3. The four streams multiplexed based on the four individual multiplexing cycles L₁-L₄. Referring to the bit pattern 810 of FIG. 8, the sequence of a bit stream (6: 4: 4: 3) forms a period and the same sequence (uniform bit pattern) is repeated thereafter. The period is defined as a multiplexing cycle (Lᵢ), and during the period, each of the repetitive uniform bit patterns is multiplexed together each time. This applies to the systems of FIGS. 4 and 5.

### Multiplexer 450 of FIG. 4 (UEP Through Modulation Only)

For the third multiplexer 450, since the data is encoded with the same code rate (R), a bit-by-bit round-robin multiplexer can be used. In this embodiment, the multiplexing cycle (Lᵢ) does not need to be calculated. In another embodiment, the multiplexing cycle (Lᵢ) for the same code rate (R) can be calculated from the states 730-750, resulting in same multiplexing order of bit-by-bit round robin multiplexing. In either case, referring to the bit pattern 820 of FIG. 8, the sequence of a bit stream (1: 1: 1: 1) forms a period and the same sequence is repeated thereafter.

### Multiplexers 550-554 of FIG. 5 (UEP Through the Combination of Coding and Modulation)

A. First Multiplexer (550)

It is assumed in the FIG. 5 system that R1=1/2 and R2=2/3. Referring to FIG. 6, the puncture cycles for rate 1/2 and rate 2/3 are 3 and 6, respectively. First, the individual puncture cycles (Nᵢ) of each rate are determined from the puncture patterns (620-640) in FIG. 6 as follows: N₁=3 and N₂=6. Also, N (the representative puncture cycle) is obtained from the relationship of: N=LCM (N₁, N₂)=LCM (1, 6)=6. Next, Mᵢ (the number of encoded bits left in each puncture cycle) is determined from the puncture patterns (620-640) of FIG. 6 as follows: M₁=2 and M₂=3. Thereafter, the multiplexing cycle (Lᵢ) is calculated as follows: L₁=(N/N₁)×M₁=(6/3)×2=4 and L₂=(N/N₂)×M₂=(6/6)×3=3. The two streams are multiplexed based on the individual multiplexing cycles L₁ and L₂. Referring to the bit pattern 830 of FIG. 8, the sequence of a bit stream (4:3) forms a period and the same sequence is repeated thereafter.

B. Second Multiplexer (552)

Since the data encode with the same rates (R1, R2) are provided to the first and second multiplexers 550 and 552, the multiplexing cycle (Lᵢ) of the second multiplexer 552 is the same as that of the first multiplexer 550 (L₁=4, L₂=3). Referring to the bit pattern 840 of FIG. 8, the sequence of a bit stream (4:3) forms a period and the same sequence is repeated thereafter.

C. Third Multiplexer (554)

For the third multiplexer 554, since the outputs of the first and second multiplexers 550 and 552 have the same data format, a bit-by-bit round-robin multiplexer can be used. As in the multiplexer 450, the sequence of a bit stream (1: 1: 1: 1) forms a period and the same sequence is repeated thereafter.

According to at least one embodiment, although different coding rates are applied to different encoders and the encoded codewords have different size, the bit streams can be multiplexed so as to provide a uniform stream for mapping operation. In addition, the multiplexer can maximize the frequency diversity for best performance which requires that the output of each encoder be spread across different subcarriers as much as possible. Furthermore, the output of the multiplexer can be in the format that fits for a simple block interleaver and UEP QAM mapper. According to at least one embodiment, the puncture cycle based multiplexer provides a simple solution for UEP and provides the highest frequency diversity for each data stream. Furthermore, it can be easily applied to multiple UEP streams with different coding rates.

Other embodiments are also possible. For example, instead of using three multiplexers 550-554 such as in the FIG. 5 embodiment, a single puncture cycle based multiplexer such as the multiplexer 350 can be used. Furthermore, instead of using a single puncture cycle based multiplexer 350 such as in the FIG. 3 embodiment, one embodiment may use three puncture cycle based multiplexers where the first multiplexer multiplexes the outputs of two encoders and the second multiplexer multiplexes the outputs of the remaining two encoders, and the third multiplexer multiplexes the outputs of the first two multiplexers).

While the above description has pointed out novel features of the invention as applied to various embodiments, the skilled person will understand that various omissions, substitutions, and changes in the form and details of the device or process illustrated may be made without departing from the scope of the invention. Furthermore, instead of an RS encoder, other error control coding (e.g., BCH encoder) can be used. Also, instead of a convolutional encoder, other encoder (e.g., linear block encoder) can be used. Therefore, the scope of the invention is defined by the appended claims rather than by the foregoing description. All variations coming within the meaning and range of equivalency of the claims are embraced within their scope.

What is claimed is:

1. A system for processing high definition video data to be transmitted over a wireless medium, the system comprising:
a plurality of parallel convolutional encoders configured to input a plurality of video data streams and output a plurality of encoded data streams, respectively; and
a multiplexer configured to multiplex the plurality of encoded data streams into a multiplexed data stream, wherein the multiplexed data stream includes a uniform bit pattern which is repeated with a period.

2. The system of claim 1, wherein at least one of the encoders has a different convolutional code rate from those of the remaining encoders

3. The system of claim 2, wherein the multiplexer is configured to i) obtain a multiplexing cycle for the plurality of encoded data streams based on code rates and puncture cycles associated with the plurality of convolutional encoders and ii) multiplex the plurality of encoded data streams based on the multiplexing cycle, and wherein the multiplexing cycle is the period during which each of the repetitive uniform bit patterns is multiplexed together each time.

4. The system of claim 1, further comprising a modulation unit configured to modulate the multiplexed data stream.

5. The system of claim 4, wherein at least one of i) the plurality of convolutional encoders and ii) the modulation unit is configured to provide unequal error protection for incoming data bits.

6. The system of claim 1, further comprising:
a Reed Solomon (RS) encoder configured to RS encode an input bit stream into an RS encoded data stream;
a parser configured to parse the RS encoded data stream into a plurality of sub-video data streams and provide the streams to the plurality of convolutional encoders, respectively;
an interleaver configured to interleave the multiplexed data stream; and
a quadrature amplitude modulation (QAM) mapper configured to modulate the interleaved data.

7. The system of claim 6, wherein the multiplexed data stream has a data format which is the same as those of the interleaver and QAM mapper.

8. The system of claim 1, further comprising an RF unit configured to transmit the multiplexed data stream to a wireless high definition video receiver which includes a plurality of parallel convolutional decoders corresponding to the plurality of convolutional encoders.

9. The system of claim 8, wherein the receiver is a HDTV set or a projector.

10. The system of claim 1, wherein the system is implemented with one of the following: a set-top box, a DVD player or recorder, a digital camera, a camcorder and other computing device.

11. The system of claim 1, wherein the multiplexer includes:
a first multiplexer configured to multiplex a portion of the plurality of encoded data streams into a first multiplexed data stream;
a second multiplexer configured to multiplex the remaining of the plurality of encoded data streams into a second multiplexed data stream; and
a third multiplexer configured to multiplex the first and second multiplexed data streams into a third multiplexed data stream, wherein the third multiplexed data stream includes a uniform bit pattern which is repeated with a period.

12. The system of claim 1, wherein the multiplexed data stream is uncompressed video signal.

13. The system of claim 1, wherein the video data includes an image data and a non-image data.

14. A method of processing high definition video data to be transmitted over a wireless medium, the method comprising:
RS encoding a received video data stream into an RS encoded data stream;
parsing the RS encoded data stream into a plurality of sub-video data streams;
convolutional encoding the plurality of sub-video data streams in parallel into a plurality of encoded data streams; and
multiplexing the plurality of encoded data streams into a multiplexed data stream, wherein the multiplexed data stream includes a uniform bit pattern which is repeated with a period.

15. The method of claim 14, wherein at least one of the plurality of encodings is performed based on a different code rate from those of the remaining encodings.

16. The method of claim 15, wherein the multiplexing comprises:
obtaining a multiplexing cycle based on code rates and puncture cycles associated with the convolutional encodings; and
multiplexing the plurality of encoded data streams based on the multiplexer cycle, wherein the multiplexing cycle is the period during which each of the repetitive uniform bit patterns is multiplexed together each time.

17. The method of claim 16, wherein the obtaining comprises:
determining individual puncture cycles (Nᵢ) for each of the plurality of video data streams based on code rates and puncture pattern associated with the convolutional encodings;
calculating a representative puncture cycle (N) from the determined puncture cycles (Nᵢ);
determining the number (Mᵢ) of encoded bits left in each puncture cycle from the respective puncture patterns; and
calculating a multiplexing cycle (Lᵢ) of the plurality of encoded data streams based on the relationship of Lᵢ=(N/Nᵢ)×Mᵢ, wherein i=1, 2, 3, . . .

18. The method of claim 17, wherein the representative puncture cycle (N) is the least common multiple (LCM) of the determined puncture cycles (Nᵢ).

19. The method of claim 14, further comprising:
determining whether the plurality of encoded data streams have the same code rate with respect to each other; and
multiplexing the plurality of encoded data streams by way of a bit-by-bit round-robin multiplexer if the input data streams have the same code rate.

20. The method of claim 14, further comprising modulating the multiplexed data stream so as to provide unequal error protection for data bits of the multiplexed data stream, wherein the plurality of encodings are performed based on different code rates with respect to each other.

21. One or more processor-readable storage devices having processor-readable code embodied on the processor-readable storage devices, the processor-readable code for programming one or more processors to perform a method of processing high definition video data to be transmitted over a wireless medium, the method comprising:
RS encoding a received video data stream into an RS encoded data stream;
parsing the RS encoded data stream into a plurality of sub-video data streams;
convolutional encoding the plurality of sub-video data streams in parallel into a plurality of encoded data streams; and
multiplexing the plurality of encoded data streams into a multiplexed data stream, wherein the multiplexed data stream includes a uniform bit pattern which is repeated with a period.

22. A system for processing high definition video data to be transmitted over a wireless medium, the system comprising:
means for RS encoding a received video data stream into an RS encoded data stream;
means for parsing the RS encoded data stream into a plurality of sub-video data streams;
means for convolutional encoding the plurality of sub-video data streams in parallel into a plurality of encoded data streams; and
means for multiplexing the plurality of encoded data streams into a multiplexed data stream, wherein the multiplexed data stream includes a uniform bit pattern which is repeated with a period.

23. A system for processing high definition video data to be transmitted over a wireless medium, the system comprising:
an error control code section configured to encode a received video data stream into an encoded data stream;
a parser configured to parse the encoded data stream into a plurality of sub-video data streams;
a plurality of parallel convolutional encoders configured to input the plurality of sub-video data streams and output a plurality of encoded data streams, respectively; and
a multiplexer configured to multiplex the plurality of encoded data streams into a multiplexed data stream, wherein the multiplexed data stream includes a uniform bit pattern which is repeated with a period.

24. The system of claim 23, wherein the error control code section is a Reed Solomon (RS) encoder or a BCH encoder.

25. A system for processing high definition video data to be transmitted over a wireless medium, the system comprising:
a Reed Solomon (RS) encoder configured to encode a received video data stream into an RS encoded data stream;
a parser configured to parse the RS encoded data stream into a plurality of sub-video data streams;
a plurality of parallel error control code sections configured to input the plurality of sub-video data streams and output a plurality of encoded data streams, respectively; and
a multiplexer configured to multiplex the plurality of encoded data streams into a multiplexed data stream, wherein the multiplexed data stream includes a uniform bit pattern which is repeated with a period.

26. The system of claim 25, wherein each of the plurality of parallel error control code sections is a convolutional encoder or a linear block encoder.

27. A system for processing high definition video data to be transmitted over a wireless medium, the system comprising:
a first error control code section configured to encode a received video data stream into an encoded data stream;
a parser configured to parse the encoded data stream into a plurality of sub-video data streams;
a plurality of second error control code sections configured to input the plurality of sub-video data streams and output a plurality of encoded data streams, respectively; and
a multiplexer configured to multiplex the plurality of encoded data streams into a multiplexed data stream, wherein the multiplexed data stream includes a uniform bit pattern which is repeated with a period.

28. The system of claim 27, wherein the first error control code section is a Reed Solomon (RS) encoder or a BCH encoder.

29. The system of claim 27, wherein each of the plurality of parallel error control code sections is a convolutional encoder or a linear block encoder.
